(19) United States
(12) Patent Application Publication
(10) Pub. No.: US 2007/0103341 A1
(43) Pub. Date: May 10, 2007

(54) Multifacted monitoring

(76) Inventors: Barrett Morris Kreiner, Woodstock, GA (US); Jonathan Lawrence Reeves, Roswell, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/267,649

(22) Filed: Nov. 4, 2005

(51) Int. Cl. G08G 1/123

(52) U.S. Cl. 340/988; 340/995.2; 340/825.49

(57) ABSTRACT

Included is a system for providing data to a user. The system can include detection logic configured to receive data related to an environment. Some embodiments can also include location logic configured to receive data related to the user's location and execution logic configured to correlate at least a portion of the data received from the detection logic and at least a portion of the data related to the user's location. Additionally some embodiments can include display logic configured to provide at least one cue that is related to the environment.

### BACKGROUND

Time can be a critical resource when an emergency response team is responding to an incident. Lives and property may depend on a rapid response. Static and dynamic environmental issues, as well as human limitations regularly inhibit the response time to these situations. As a nonlimiting example, due to various forms of street numbering, emergency response teams oftentimes have difficulty in locating the house (or business) from which an emergency arose. Because the emergency personnel may not be familiar with the particular area, valuable time can be wasted in searching for the location of the emergency. Additionally, environmental factors, such as darkness, rain, smoke, flooding, downed trees, downed power lines, etc., can inhibit the emergency response unit from quickly locating and treating the emergency.

Additionally, in some emergencies, multiple emergency response units with multiple teams of emergency personnel may be requested to respond to an emergency. If one of the teams encounters an obstacle preventing access to the emergency via one particular route, the other teams may desire an alternate route. However, oftentimes, the other teams are unaware of the obstacle, or do not know of an alternate route to reach the emergency. In such a situation, time may be lost in responding to the emergency.

As an additional nonlimiting example, various other information such as location of fire hydrants, location of pedestrians, etc., may be invaluable to decreasing the response time of an emergency while maintaining the safety of those in the area.

Thus, a heretofore unaddressed need exists in the industry to address the aforementioned deficiencies and inadequacies.

### SUMMARY

Included in this disclosure are systems and methods for communicating data. In at least one embodiment, this disclosure discusses a system for providing data to a user that includes detection logic configured to receive data related to an environment and location logic configured to receive data related to the user's location. This embodiment also includes execution logic configured to correlate at least a portion of the data received from the detection logic and at least a portion of the data related to the user's location and display logic configured to provide at least one cue that is related to the environment.

Other embodiments include a method for providing data to a user. Embodiments of the method include receiving data related to an environment, receiving data related to the user's location, and correlating data received from the detection logic and at least a portion of the data related to the user's location. Other embodiments of the method include providing at least one cue related to the environment.

Other embodiments described in this disclosure include a computer readable medium for providing data to a user. Embodiments of the computer readable medium include logic configured to receive data related to an environment, logic configured to receive data related to the user's location, and logic configured to correlate data received from the detection logic and at least a portion of the data related to the user's location. Other embodiments include logic configured to provide at least one cue related to the environment.

Other systems, methods, features and/or advantages will be or may become apparent to one with skill in the art upon examination of the following drawings and detailed description. It is intended that all such additional systems, methods, features and/or advantages be included within the scope of the present invention and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a perspective view diagram illustrating a nonlimiting example of an emergency response unit responding to an emergency.

FIG. 2 is a perspective view diagram illustrating an exemplary driver's view from the emergency response unit from FIG. 1.

FIG. 3 is a perspective view diagram illustrating a visual detection system on the emergency response unit from FIG. 1 according to an exemplary embodiment.

FIG. 4 is a perspective view diagram illustrating an exemplary driver's view from the emergency response unit from FIG. 3.

FIG. 5 is a functional block diagram illustrating an exemplary embodiment of an emergency response communications system that may be configured to communicate with the emergency response unit from FIGS. 1 and 3.

FIG. 6 is a screenshot view of a geographical location at two different times that may be presented to a user pursuant to the configuration from FIG. 5, according to an exemplary embodiment.

FIG. 7 is an alternative screenshot view of a geographical location at two different times that may be presented to a user pursuant to the configuration from FIG. 5, according to an exemplary embodiment.

FIG. 8 is a functional block diagram illustrating an exemplary embodiment of the on-board emergency response system from FIG. 4.

FIG. 9 is a flowchart diagram of actions that may be taken with an emergency response unit, such as illustrated in FIGS. 1 and 3, according to an exemplary embodiment.

FIG. 10 is a flowchart diagram of actions that may be taken in an emergency response unit from FIG. 3, according to an exemplary embodiment.

FIG. 11 is a flowchart diagram of actions that may be taken in an emergency response communications system, such as the system from FIG. 5, according to an exemplary embodiment.

### DETAILED DESCRIPTION

When an emergency occurs, a communication is generally initiated to an emergency response dispatcher via any of a plurality of ways, for example, placing a call to “911.” When a call is placed to 911, the dispatcher generally initiates a communication to the desired emergency response division (or divisions), such as the fire department, hospital, or police. A communication may be further initiated to determine which emergency response teams can be sent.

As a nonlimiting example, if there is a fire at 125 Freckle Street, a person can dial 911 to alert the emergency response dispatcher of the emergency. Depending on the particular configuration, the dispatcher can then determine the closest fire station to 125 Freckle Street. In some instances, the dispatcher may determine that the service from multiple fire stations is desired. The dispatcher can then initiate a communication to the desired fire station or stations to relay the emergency information. The emergency information may include the address of the emergency (125 Freckle Street), default directions to the emergency, the number of people involved, the probable type of fire, etc. With this information an emergency response team from the fire station assembles in an emergency response unit (in this nonlimiting example a fire truck). The emergency response team can then locate the emergency and take an appropriate response to save lives and property.

One problem with the above-described scenario is that the dispatcher may be unaware of the present conditions that the emergency response unit is encountering. Such conditions may include, for example, inconspicuous houses or house numbering, inclement weather, darkness, traffic, unknown obstacles, and other conditions that may delay or inhibit the emergency response unit from finding the emergency. Further, misinformation may be communicated from the dispatcher due to construction, street name changes, and unorthodox street numbering and naming.

As a nonlimiting example, the dispatcher may provide the emergency response team with an address (125 Freckle Street) and directions to find this address. Upon following the directions, the emergency response team may still not be able to find the emergency. At this point the emergency response team may not be able to determine if the directions that the dispatcher provided is incorrect, if communication from the dispatcher and the emergency response team was corrupted, if the emergency response team incorrectly followed otherwise correct directions, or if the emergency response team is unable to find the emergency location due to an inconspicuous location of the emergency (no house number, in the woods, etc.). The emergency response team may be limited to turning on the siren and having the caller tell the dispatcher when the siren gets louder and softer. Such a scenario may greatly increase response time to a point that lives may be lost.

At least one embodiment of the present disclosure includes a visual windshield display that can include a dynamic icon providing various data to the emergency response team. The icon can have depth, appear solid, and can take the shape of a three-dimensional arrow, as one nonlimiting example, among others. The arrow can visually run ahead of the apparatus, and when a turn is indicated, can change its direction and “wait” at the turn as the apparatus approaches. The distance and closing speed to the turn can be used to change the color of the arrow. In operation, the curvature of the windshield and the eye positions of the operator can be taken into account to provide a true depth perception to the operator. The windshield can also include an overlay with an embedded light emission or LCD screen (or both). A parallax barrier display can also be used, and allow a 3D image to be created from alternate LCD rows.

As a nonlimiting example, the color green can indicate a safe distance, while the color yellow can indicate that the distance is closing. The color red can indicate that immediate action is desired. Additionally, the system can include an audible notification, such as an aircraft marker proximity warning. Once the apparatus has made a turn, the arrow can race ahead to continue to lead the emergency response unit. At the destination, the arrow waits and changes to a different icon, such as a stop sign, or other indicator. Additionally, other embodiments can include other visual indicators such as visual text, directional audio commands, etc.

The system can also be configured for traffic awareness, via cameras, radar, ultra-wide band echo, and other means. Likewise, pedestrians and other hazards can be identified by “augmented peripheral vision” and can be highlighted, contrasted, identified with a halo, etc. to increase the awareness of the (potential) hazard. During an emergency response, the emergency response unit may bypass certain road rules, crossing a red light or stop sign. The system can be configured to highlight vehicles approaching that would normally have the right of way. Computer aided lights and sirens, directed at those vehicles, can also be employed as part of this system to improve the overall safety of the situation.

Additionally, the system can be configured to be aware of speed limits, and other traffic laws and rules. In at least one embodiment the windshield display can be configured to pace the apparatus according to speed limits. As a nonlimiting example, a department's rules may state that an emergency response unit is limited to no more than 10 MPH over the posted speed limit. The system can thus be configured to provide an arrow that moves ahead of the apparatus no more than 10 MPH over the posted speed limit. If the apparatus is slower than 10 MPH, the arrow will not exceed a predetermined distance. However if the apparatus exceeds the speed, the distance between the arrow and the apparatus will appear to reduce, thereby creating the impression that the fire truck is crowding or tailgating the arrow and the normal reaction of a driver will be to slow down the apparatus.

Cameras, radar, heat detection, and other means of collecting environmental data can be configured with extended frequency or color range (or both), for reaching into the infrared region of the spectrum. In an environment with low light or no light, the color spectrum can become compressed and items of interest can be highlighted to the driver. Additionally, road dogs can be easily located, identified, or virtually displayed and a virtual center line can be superimposed for the driver. This idea can also be used in conjunction with the mirrors on a response unit to a driver in reversing the response unit.

The system can also be configured to record the environment as the unit proceeds. This data can be associated with a Global Positioning System (GPS) or other location logic. Multiple passes of an area can build up the static data (house, driveway, hydrant locations, etc.) versus dynamic data (parked cars, dumpsters, etc.) allowing the system to provide intelligent information about the surrounding area.

For low light conditions, a “virtual sunlit” superimposition view can be provided, to at least one member of the emergency response team. The “virtual sunlit” view can be derived from the last recorded sunlit view of this area. Additionally, using character recognition street numbers can be identified from curbs, mailboxes, front doors, etc. The system can also be configured to display house numbers when the emergency response unit is within reasonable distance of the destination address. Road signs with street numbers and street names can also be displayed. Associating this information with a map can also allow for a more refined target. Additionally, when arriving at an emergency, a virtual lot map or floor plan (or both) can also available.

Traffic patterns can also extend the response time. Rush hour versus midnight traffic can change the nature of road infrastructure utilization. The system disclosed herein can take this information into account, and adapt the response route based on historic information, preferred routes, alternate routes, and the current traffic conditions. This data can be gathered from traffic management systems, cameras, radar, Ultra Wide Band (UWB) echo, manual entry by systems, operators, or others, or from other sources. Networked infrastructure can also allow multiple emergency response units to adapt their response path based on the lead emergency response unit. In at least one embodiment, the emergency response units can be configured to communicate with each other, providing at least a portion of the above listed information to improve their response efficacy.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

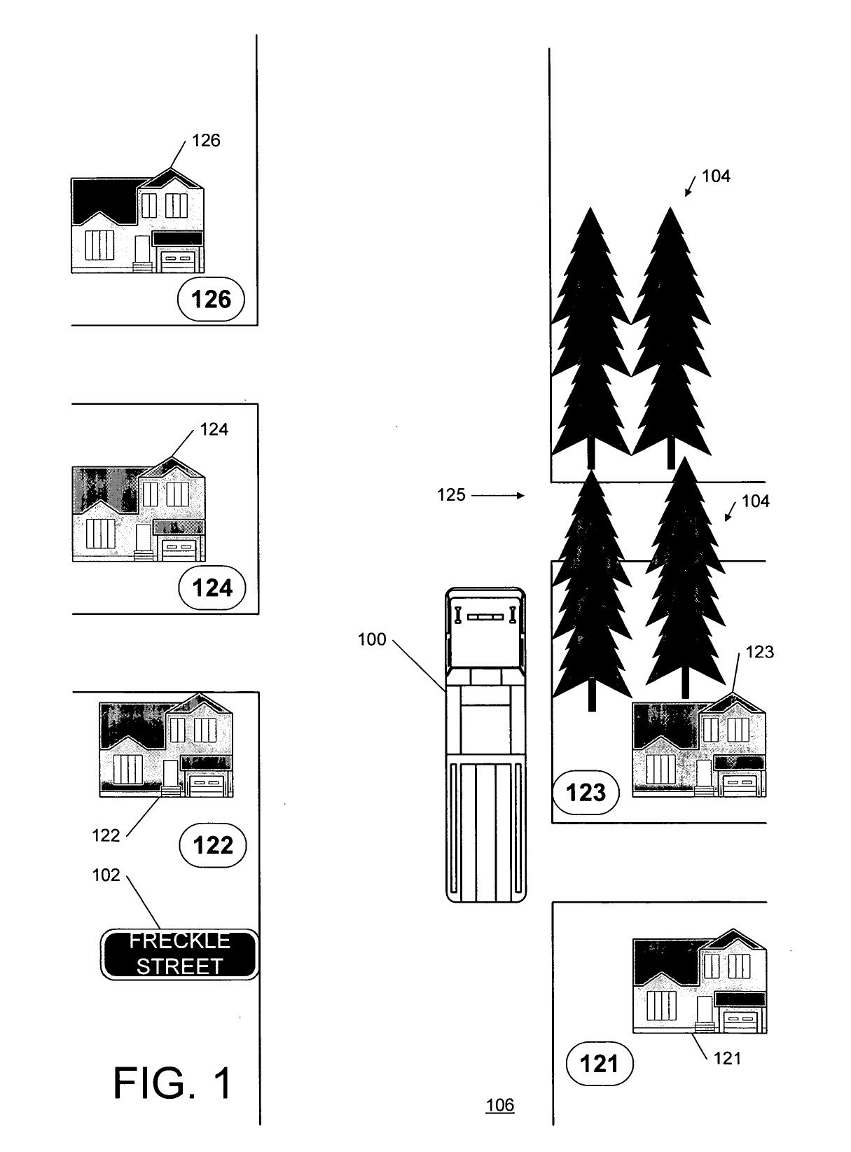

FIG. 1 is a perspective view diagram illustrating a nonlimiting example of an emergency response unit that is responding to an emergency, according to an exemplary embodiment. As illustrated, emergency response unit 100 receives a communication from a dispatcher (or other source) indicating that there is an emergency at 125 Freckle Street. The dispatcher can indicate that the emergency is that a person at 125 Freckle Street is currently in “cardiac arrest.” As is evident to one of ordinary skill in the art, unlike a fire that will typically produce smoke, an emergency such as this may not have any environmental indicators of its location. The emergency response team may be forced to simply rely on the information provided by the dispatcher, to find the emergency.

As the emergency response unit 100 reaches Freckle Street (106), as indicated by street sign 102, the emergency response team may locate 121 Freckle Street, 122 Freckle Street, 123 Freckle Street, 124 Freckle Street, and 126 Freckle Street from the visible house numbering corresponding to each house. However, due to a missing house number and the presence of a plurality of trees 104 that block the entrance to 125 Freckle Street (125), the emergency response team may be unable to determine the presence or location of the emergency. The house located at 125 Freckle Street may not be visible from the street 106, or otherwise may not be conspicuous to the emergency response team.

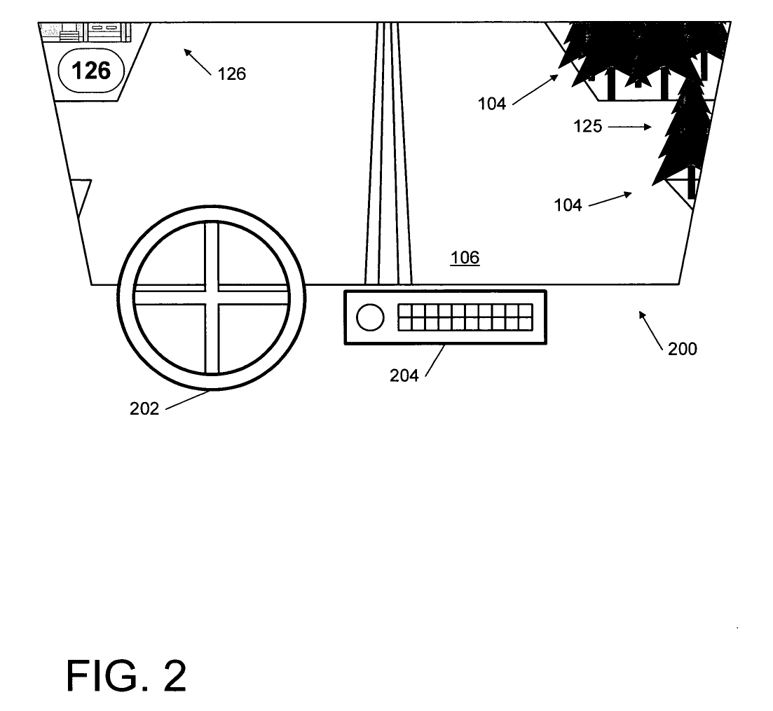

FIG. 2 is a perspective view diagram illustrating a driver's view from the emergency response unit from FIG. 1. As illustrated the driver of the emergency response unit may have visual indication of 126 Freckle Street through windshield 200. However, due to the trees 104 and the inconspicuous entrance to 125 Freckle Street, the emergency response team may not be able to locate the location of the emergency. Additionally, despite information provided by the dispatcher via communications unit 204, the response time for the current emergency may be increased.

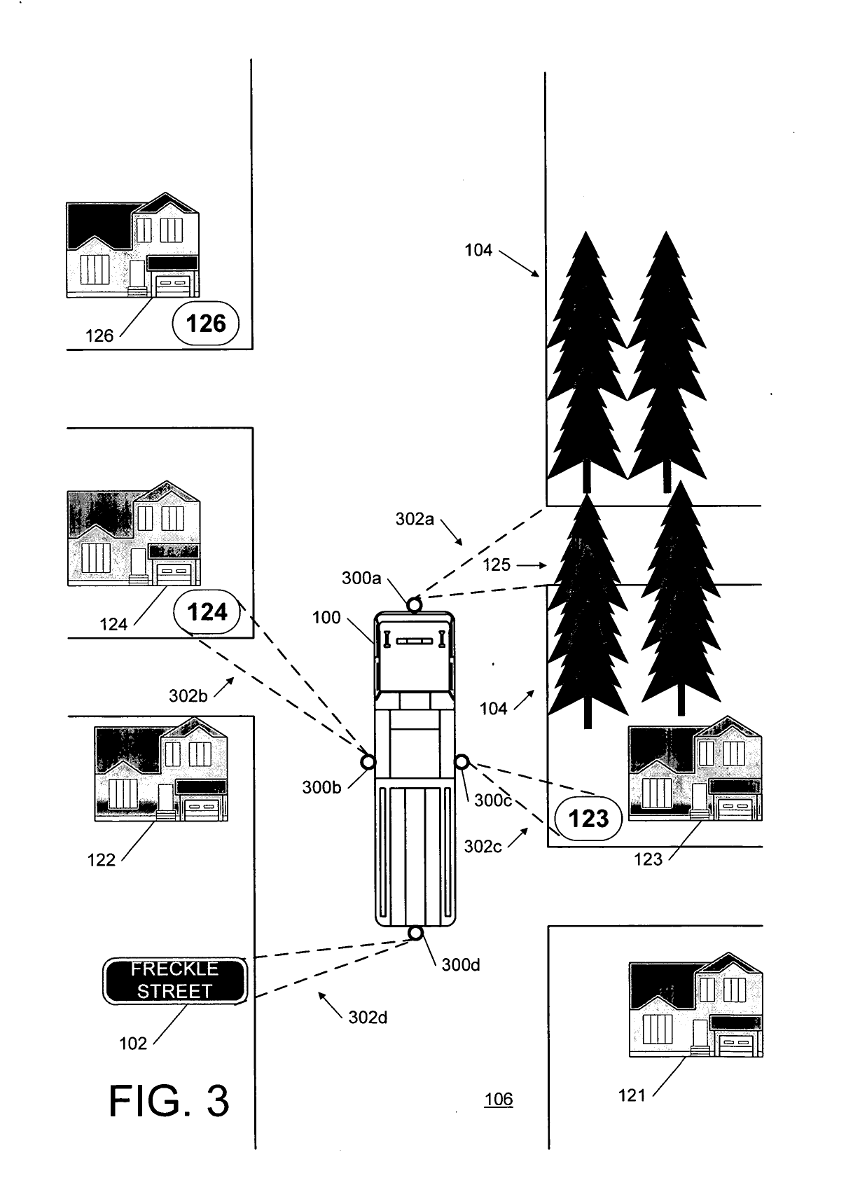

FIG. 3 is a perspective view diagram illustrating a visual detection system on the emergency response unit from FIG. 1, according to an exemplary embodiment. As illustrated, the emergency response unit 100 can be equipped with a plurality of visual detection devices 300a, 300b, 300c, and 300d, that can be configured to scan the geography that the emergency response unit encounters. The visual detection devices 300a, 300b, 300c, and 300d may scan the geography via a scanning spectrum 302a, 302b, 302c, and 302d, respectfully. The visual detection devices 300 may include character recognition logic, volumetric logic, and other forms of logic that may be configured to recognize various objects and locations of the geography.

As a nonlimiting example, the visual detection device 300d may perceive visual data that includes the street sign 102. Logic associated with a visual detection system may determine that this is a street sign, and character recognition logic may determine that the street sign indicates that this street is Freckle Street. A Global Positioning System (GPS) or other location system may also be associated with the emergency response unit such that a documentation of the global location of the emergency response unit may be correlated with the perception of the Freckle Street sign 102. From this information, the visual detection system may determine that the emergency response unit is currently on Freckle Street.

Additionally, the visual detection device 300b may perceive the posted house number 124 corresponding to 124 Freckle Street. Visual detection device 300c may perceive the posted house number 123 corresponding to 123 Freckle Street. Further, visual detection device 300a may perceive a driveway 125 that does not appear to correspond with a house number.

Depending on the particular configuration of the visual detection system, logic may be configured to automatically determine that because the other houses on Freckle Street correspond to a numbering scheme, and this unmarked driveway has no number, this driveway must correspond to 125 Freckle Street. Alternatively, an alert may be presented to the emergency response team that an unknown driveway is present on the right side of the street. Other information provided to the emergency response team may include the documentation of the Freckle Street sign 102, and its global position, as well as the location of 123 Freckle Street, 124 Freckle Street, and other documented addresses located on Freckle Street. From this information, the emergency response team may determine that the driveway 125 might correspond with 125 Freckle Street.

One should note that character recognition technology may be employed to facilitate this process with current street signs, house numbering schemes, etc. However this is not a necessity, as at least one embodiment could include marker tags that are easily perceivable by the visual detection system. In this nonlimiting example, a tag such as a Radio Frequency Identifier (RFID) tag may broadcast the information that is printed on the sign (or house number or other identifying information). Additionally, similar markers on curbs may facilitate the location of driveways and side streets that may not be easily visible. Thus, vision detection devices and vision detection system may or may not incorporate the perception of “visual” data. Additionally, while RFID tags are used herein as a nonlimiting example, this is not intended to limit this disclosure. Other embodiments could include GPS or other similar technology, without the use of RFID tags. As is evident to one of ordinary skill in the art, any form of communicating the desired data to the emergency response team may be employed.

Additionally, while street signs, house numbering, and driveways are described above as the information that can be gathered by a visual detection system, these are but nonlimiting examples. Other information can also be presented to the emergency response team, including the location of pedestrians, the location of fire hydrants, etc.

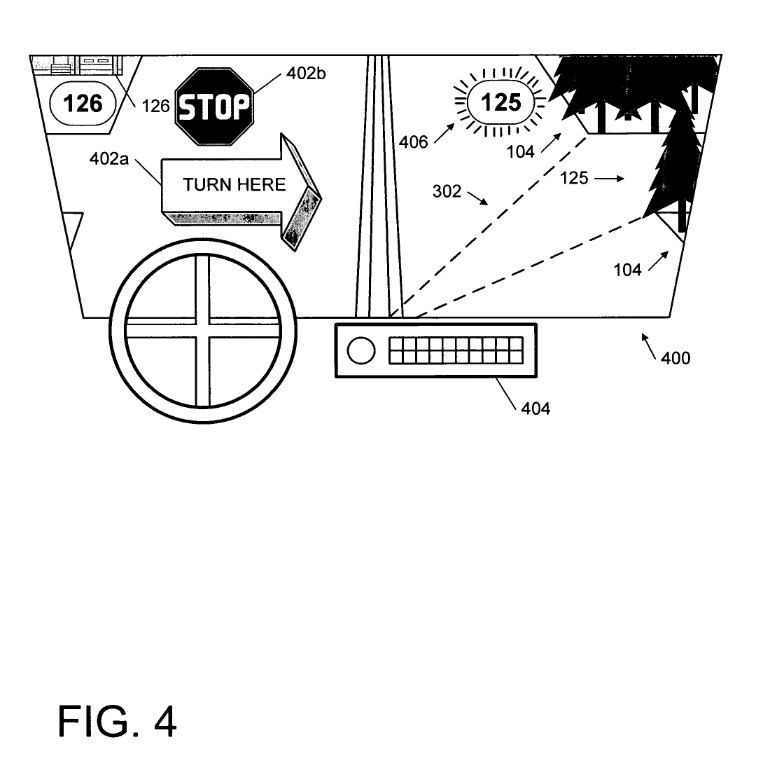

FIG. 4 is a perspective view diagram illustrating a driver's view from the emergency response unit from FIG. 3, according to an exemplary embodiment. As illustrated, the emergency response team may have a view of the geography that may be impeded by the emergency response unit, or other obstacles encountered while driving. As such, an on-board emergency response system 404 may be associated with the emergency response unit 100 to provide the emergency response team with visual cues that may aid in the location of an emergency.

In at least one embodiment, the on-board emergency response system 404 includes a heads-up windshield display, or other means of displaying the information to the emergency response team including, but not limited to virtual reality or holographic technology. Regardless of the technology implemented, virtual cues can be provided to at least one member of the emergency response team. At least one nonlimiting example may include a retinal detector for determining the position of the driver's eyes. The retinal detector can communicate with a projection device to display the cues according to the position of the driver's eyes. As a nonlimiting example, if the driver is six feet tall, the projection device can project the windshield cues relative to that position. However, if the driver is five feet, five inches, the projection will likely change based on this driver's retinal position.

The windshield cues can include various information related to the emergency, as well as other information that may be helpful to the emergency response team. As a nonlimiting example, GPS and other mapping systems generally provide a user with an overhead map and corresponding directions for reaching the desired destination. In at least one embodiment of this disclosure, the windshield display is configured to communicate the instructions that may be provided by the dispatcher to the emergency response team in a three dimensional manner. In at least one implementation, the windshield display can be configured to provide the emergency response team with a three dimensional arrow that points in the direction of the desired route. Colors and other indicators may alert the emergency response team to distances for turns, obstructions, etc.

The system can also include logic coupled to the unit's speedometer with a computer interface to a vehicle controller computer to determine the emergency response unit's speed and compare this data with speed limits, turns, obstacles, etc. This information can be communicated to the windshield display to provide cues as to safe turning speed with respect to a particular turn, as well as other information.

As a nonlimiting example, the emergency response unit may receive data related to an emergency. The data can include an address or directions associated with the emergency (or both). A GPS unit coupled to the emergency response unit can provide positioning information, and logic associated with the emergency response unit may provide data to a windshield display. According to the GPS data and the emergency data, an arrow may be displayed to the driver of the emergency response unit on the windshield that indicates when and where to turn, as well as indicators for speed, location of pedestrians, fire hydrants, and the destination.

Referring back to FIG. 4, the emergency response unit 100 may be driving down Freckle Street, with the emergency response team searching for the house corresponding to 125 Freckle Street. Because the vision detection system has located 123, 124, and 126 Freckle Street (or other data related to 125 Freckle Street that has been previously recorded), the vision detection system can locate driveway 125 via scanning spectrum 302 and can associate this data with 125 Freckle Street. Knowing that this is the location of the emergency, visual cues 402a, 402b, and 406 can be presented to the driver on windshield display 400 (or other means) via on-board emergency response system 404. Additionally, audio cues can also be presented to more fully provide the driver with the location of 125 Freckle Street.

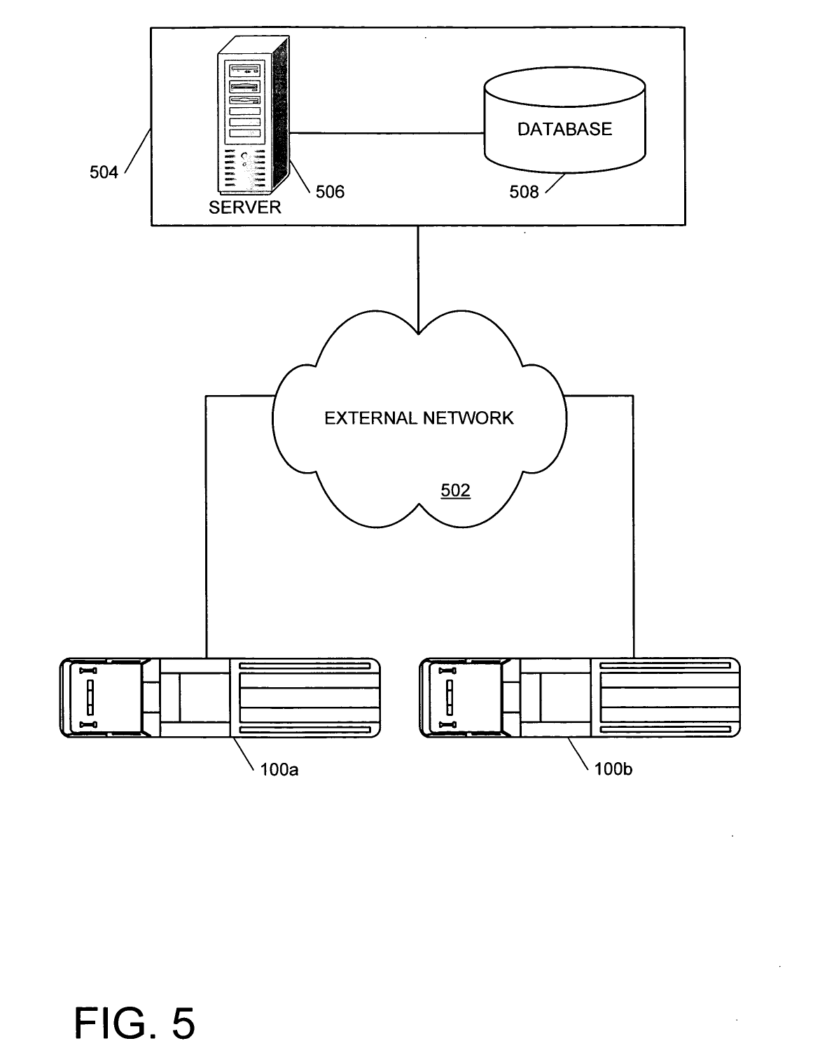

FIG. 5 is a functional block diagram illustrating an embodiment of an emergency response communications system that may be configured to communicate with the emergency response unit from FIGS. 1 and 3, according to an exemplary embodiment. As illustrated, an emergency response communications system may include a host network 504, which may include a server 506 and data storage logic, represented as a database 508. The host network may be located at the dispatcher, or at the emergency response division such as a fire station, police station, hospital, or other locale. The emergency response communications system may be configured to store and communicate data related to the emergency. Also included in the system of FIG. 5 is an external network 502 coupled to host network 504. The external network 502 may include a communications medium, which may include a wireless network, the Internet, or other communications medium for communicating various forms of data. Coupled to the external network 502 are a plurality of emergency response units 100.

In operation, the emergency response communications system 504 may receive data related to an emergency. This data may be manually inputted by a human dispatcher, may be derived from the initial “911” call, or may otherwise be communicated to the emergency response communications system 504. In a first embodiment, the emergency response communications system 504 determines a default route for at least one emergency response unit and stores data in the database 508 related to a default route for the emergency. However, other embodiments can include an emergency response unit 100 configured with logic to determine a default route and communicate this information with emergency response communications system 504. Further communication between the emergency response unit 100 and the emergency response communications system 504 can allow the emergency response communications system to provide information regarding other emergency response units and the obstacles they encounter.

As a nonlimiting example, if a first emergency response unit 100a encounters a flooded street that is impassible, the first emergency response unit 100a can communicate this information to the emergency response communications network 504, which can then communicate this information to other units, (e.g., unit 100b) whose desired travel route includes the flooded street. Data related to other obstacles, such as traffic, automobile accidents, etc. may also be useful to units that may have a desired route that may be impeded by the obstacle.

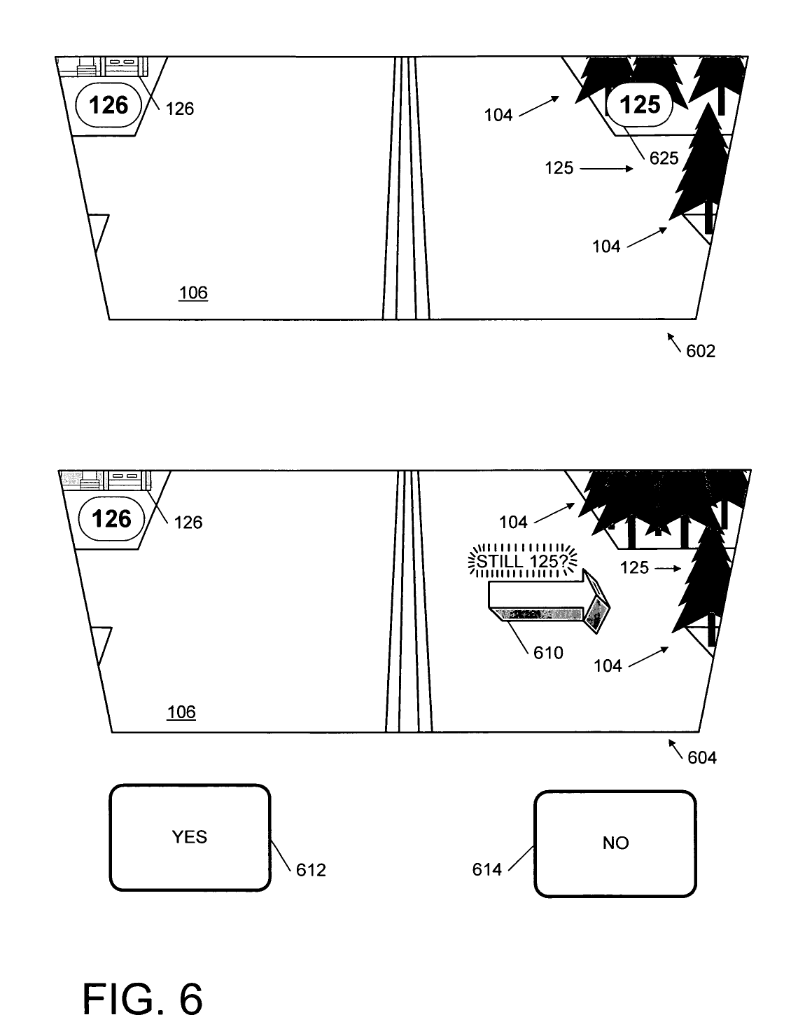

FIG. 6 is a screenshot view of a geographical location at two different times that may be presented to a user pursuant to the configuration from FIG. 5, according to an exemplary embodiment. With respect to FIGS. 3, 4, and 5, an emergency response unit can be configured to compile data regarding various geographical locations. This information can include visual data related to various locations. As this data is being compiled, the emergency response unit can be configured to compare this data with data of the same location that has been previously been compiled. Alternatively, the visual data can be communicated to the emergency response communications system 504. The emergency response communications system 504 can compile the data received from the emergency response unit 100 and compare it with data received from all emergency response units. The system can be configured to compare the data previously stored with respect to the location, and either automatically update the information of request user confirmation to update the information.

As a nonlimiting example, visual detection device(s) 300 can capture data related to the screenshot 602 of Freckle Street on Jul. 19, 2005. On Jul. 20, 2005 a visual detection device 300 may capture data related to the screenshot 604. The July 19 screenshot includes recognition of 124 Freckle Street, as well as recognition of the

Freckle Street sign 625. The data from July 20 however is missing the 125 Freckle Street sign 625. A user prompt may then be provided to verify that the data related to 125 Freckle Street is still valid via indicator 610, and selectable options 612, 614. The user can then select the appropriate option.

As illustrated in FIG. 6, the data verification can occur via the windshield display, keyboard, or other input devices as described with regard to FIG. 4. As the emergency response team is driving the emergency response unit, various data may be confirmed. However, this is but a nonlimiting example. In at least one embodiment, this data can be compiled and compared at a later time, or the data may be communicated to the emergency response communications system 504 for validation.

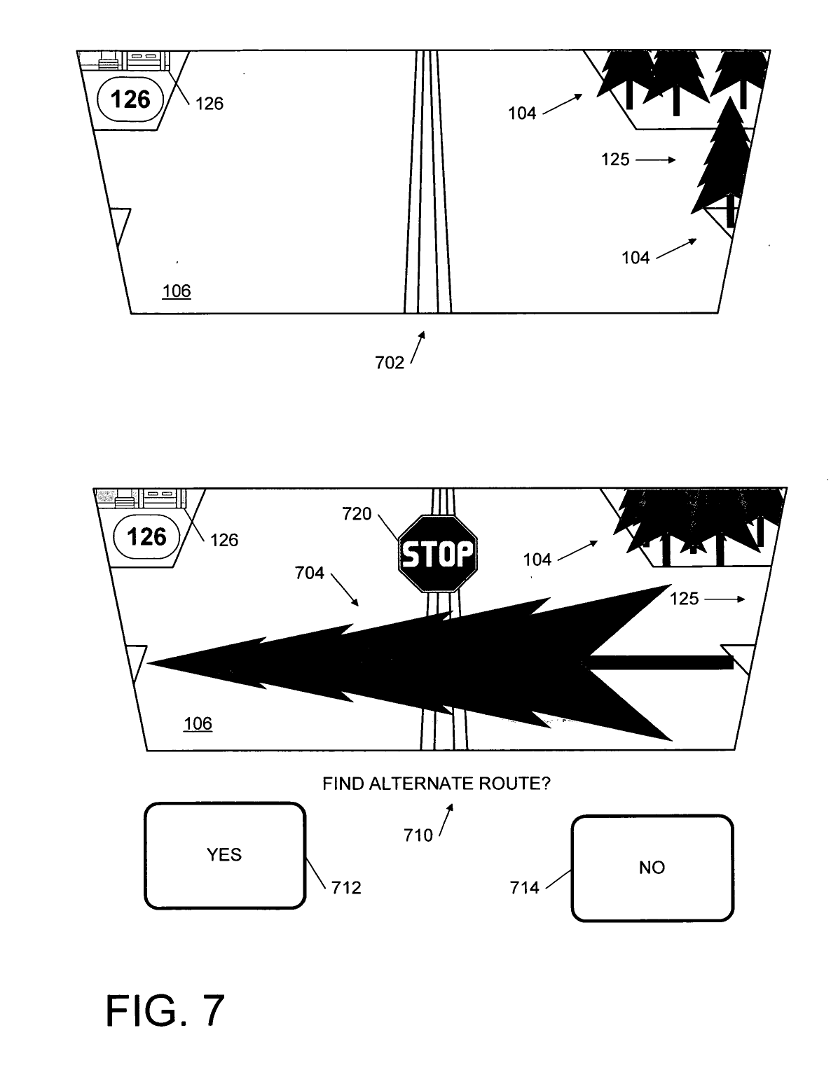

FIG. 7 is an alternative screenshot view of a geographical location at two different times that may be presented to a user pursuant to the configuration from FIG. 5, according to an exemplary embodiment. In this nonlimiting example, the vision detection devices can determine an obstacle that may prevent the emergency response unit 100 from continuing on the desired path to the emergency. This determination may be presented to a member of the emergency response team, who may then select the desired course of action. As illustrated in FIG. 7, the top screenshot 702 illustrates the house number for 126 Freckle Street, the driveway for

Freckle Street, and a plurality of trees 104. In the bottom screenshot 704, one of the trees has fallen into the street. The vision detection system can determine that the road is now impassible. Additionally, the system can prompt a member of the emergency response team as to whether the system should find an alternate route as is illustrated with prompt 710, and provide at least one member of the emergency response team with visual or audio cues (or both) such as stop sign 720. If the emergency response team determines that the tree can be moved, an indication can be made 714 that the road will be clear, and that other emergency response units can also take this route. If the emergency response team determines that the tree is not movable, an alternate route may be requested via the user prompt 712. This information can be communicated to the emergency response communications system 504, which can suggest alternate routes for other emergency response units. Alternatively, the on-board emergency response unit 404 can also be configured to provide an alternate route.

One should note that vision detection system can be configured to locate the obstacle without comparing previous vision data on the geographic location. However, vision detection system may compare previous data in order to determine the cause of the obstruction (i.e., the fallen tree). This data may be beneficial for dispatch to deploy other emergency response units to clear the obstacle from the road or to make an assessment as to what emergency vehicles may be affected by the obstruction. As a nonlimiting example, if unit A is a rear-wheel drive vehicle, the default route may be impassible. However, if unit B is a 4-wheel drive vehicle, the obstacle may have no effect. The emergency response communications system 504 can be aware of the various capabilities of each emergency response unit 100, and can customize instructions, and other data accordingly.

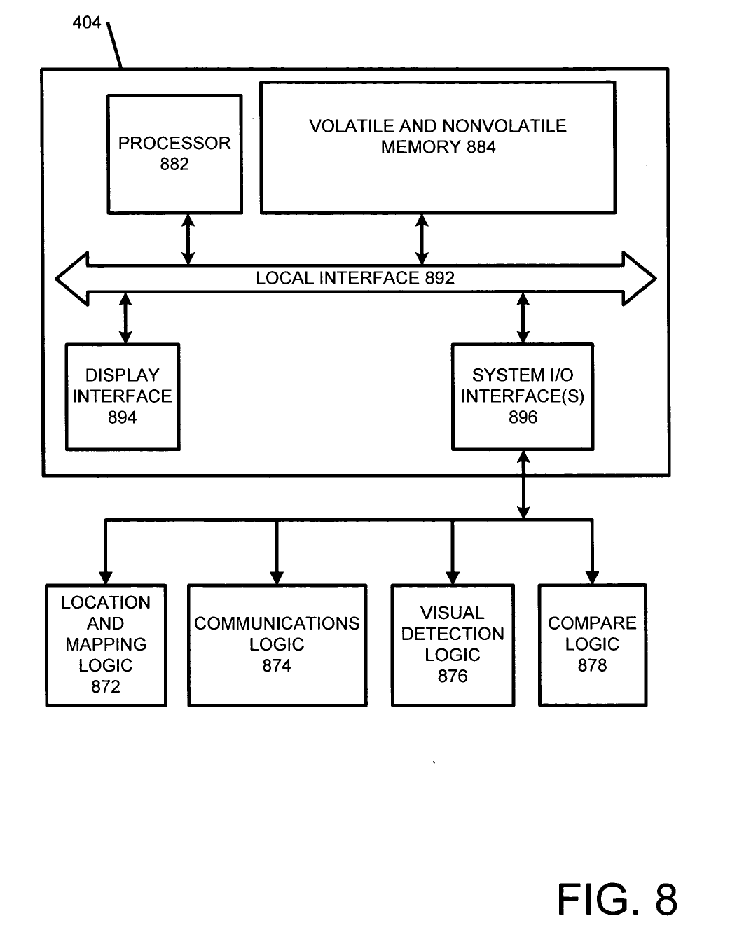

FIG. 8 is a functional block diagram illustrating an exemplary embodiment of the on-board emergency response system from FIG. 4. As illustrated, the on-board emergency response system 404 includes a processor or execution logic 882 coupled to a local interface 892. Also coupled to the local interface 892 is volatile and nonvolatile memory 884, which includes various software components. Also coupled to the local interface 892 is a display interface 894, a system input/output interface(s) 896, test input interface(s) 898, and test output interface(s) 899.

Also included in this nonlimiting example are location and mapping logic 872, communications logic 874, visual detection logic 876, and compare logic 878. The location and mapping logic 872 can include a GPS receiver and logic configured to determine the unit's location, and potential routes to a desired location. Also included is communications logic 874, which may be configured to communicate location data determined by the location and mapping logic 872. Other communications including one and two-way communications with the dispatcher may also be facilitated by the communications logic 874.

The on-board emergency response system 404 can also be coupled to visual detection logic 876 configured to facilitate operation of the visual detection system. The visual detection logic 876 can be configured to store various data related to the visual data received, however, this function may be reserved for volatile and nonvolatile memory 884. As a nonlimiting example, the visual detection logic 876 can be configured to communicate data to the volatile and nonvolatile memory 884. Additionally included in this nonlimiting example is compare logic 878, which can be configured to compare data related to previously stored visual data with data related to currently received visual data. As a nonlimiting example, referring to FIG. 6, the comparison logic 878 can facilitate a comparison of a previous screenshot with the current screenshot to provide a emergency response team member (or a dispatcher) an option of updating the information.

One should note that other logic or components (or both) can also be included in the nonlimiting example discussed with reference to FIG. 8. Similarly, elements discussed with respect to this nonlimiting example can be removed, depending on the particular operation. Additionally, while the components 872-878 are illustrated in FIG. 8 as being separate from emergency response system 404, this is but a nonlimiting example. As is evident to one of ordinary skill in the art, any or all of this logic may be software, hardware, etc. that is included within emergency response system 404. Also, one or more of elements 872-878 can be implemented within volatile and nonvolatile memory 884 in whole or in part for execution by processor 882.

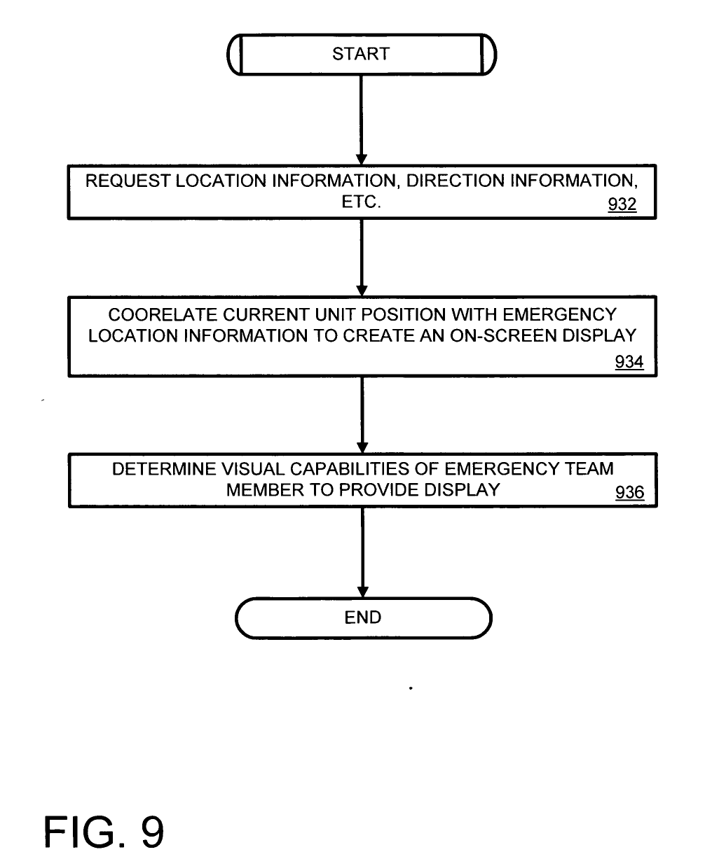

FIG. 9 is a flowchart diagram of actions that may be taken with an emergency response unit, such as illustrated in FIGS. 1 and 3, according to an exemplary embodiment. A first step in this nonlimiting example is to request location information, direction information, etc. (block 932). The request can take the form of an emergency response unit 100 requesting all the information from the emergency response communications service, however this is not a requirement. At least one other embodiment might include the emergency response unit 100 requesting at least a portion of this information from logic coupled to the emergency response unit. One should note that while the first step illustrated in this nonlimiting example is to request data, this is also a nonlimiting example. In at least one embodiment a requesting step is not taken, as the emergency response communications service communicates the information to the emergency response unit without a request being made.

The next step of this nonlimiting example is to correlate current emergency response unit 100 position with emergency location information to create an on-screen display (block 934). The current engine position may be provided via an on-board GPS, however this is not a requirement. In at least one embodiment, the location information is provided via the emergency response communications system 504. With the current emergency response unit 100 position information and the emergency location information, windshield or on-screen display may be presented, as described above, with reference to FIG. 4. The system can then determine the visual capabilities and eye position of at least one member of the emergency response team, to appropriately provide the on-screen display (block 936).

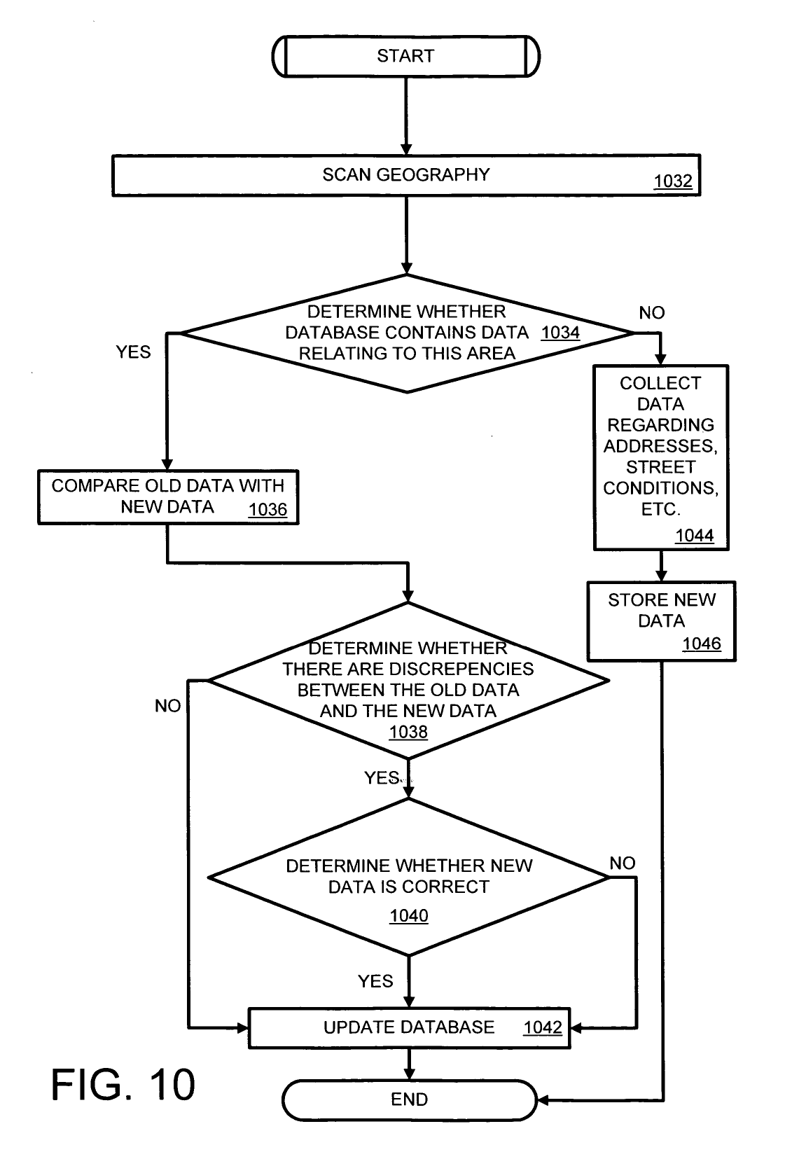

FIG. 10 is a flowchart diagram of actions that may be taken in an emergency response unit from FIG. 3, according to an exemplary embodiment. The first step in this nonlimiting example is to scan the geography (block 1032). As discussed above, an emergency response unit 100 can be configured with at least one visual detection device 300 that can scan geography. The data can be stored locally, in association with the on-board emergency response system 404, or the data can be communicated to the emergency response system 504 pursuant to FIG. 5. Regardless of the storage technique, a determination can be made as to whether data related to this location has previously been recorded (1034). If this geography has not been scanned before, data related to the geography can be scanned (block 1044). The data can include street names, addresses, street conditions, etc. Once the geography is scanned, the data relating to the geography can be stored (block 1046). The stored data can include visual data such as screenshots or video (or both), however this is not a requirement. In at least one embodiment, data related to significant geographical indicators may be recorded and the visual data may be discarded. More specifically, if a visual scanning system captures visual data related to Freckle Street (as illustrated in FIG. 3), the system may recognize the Freckle Street sign 102, and realize that all house numbers are related to Freckle Street. When a house number is received via the visual scanning system, such as 123, the system can determine that 123 Freckle Street is associated with the geographic location indicated via the location and mapping logic 872 (FIG. 8). Therefore, the actual visual data acquired may be discarded in many circumstances.

Referring back to block 1034, if it is determined that this geographical area has been scanned before, a comparison can be made to determine if significant geographical indicators (such as street signs, house numbers, store signs, buildings, etc.) are the same as in the previously stored data (block 1036, 1038). If the two sets of data are the same, the process can end. However, if the two sets of data are not the same, the user can be prompted to confirm that the data has in fact changed (block 1040). If the new data is not correct, the system can store information regarding this discrepancy such that the scanning mistake is not repeated (block 1042). If, the new data is correct, and the system can replace the old data with the new data (block 1040). Additionally, the system can be configured to differentiate between permanent objects and temporary objects. Permanent objects can include houses, street signs, curbs, etc. Temporary objects, on the other hand, can include cars, pedestrians, etc. that are not expected to remain in the same location over a given period of time. The determination between permanent objects and temporary objects can take many forms. In at least one embodiment, the system can be configured to determine a classification of each object scanned, and perform a comparison of that data with data associated with permanent objects and temporary objects. If the scanned object is classified as a temporary object, it can be removed from relevance.

As another nonlimiting example, the system can provide a user the opportunity to determine which objects are temporary and which objects are permanent. In another nonlimiting example, the system can simply compare an area at various times to determine what objects are permanent, and which objects are temporary. Additionally, in at least one embodiment, the logic can also determine that certain temporary objects are routinely present in a certain area, and that caution should be taken when the emergency response unit is present in that area. As a nonlimiting example, if the system determines that pedestrians are common to Freckle Street, a warning can be provided to the emergency response team to take extra caution when in this area.

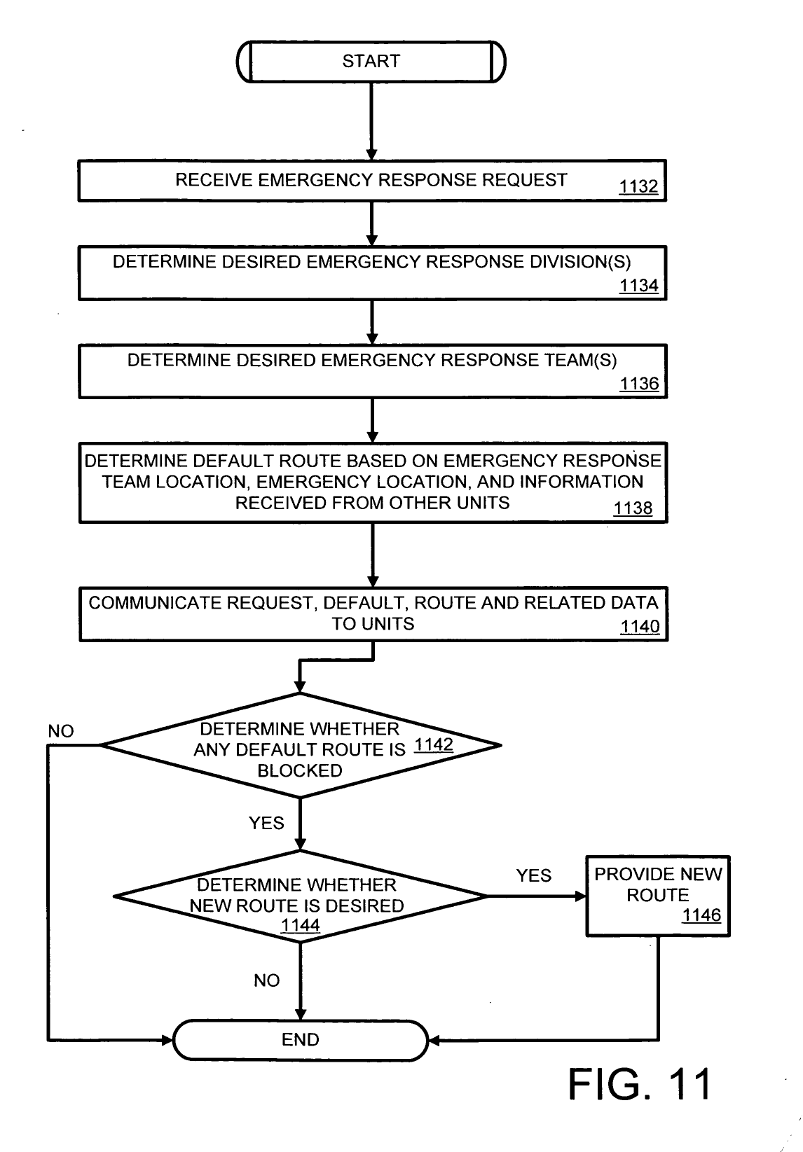

FIG. 11 is a flowchart diagram of actions that may be taken in an emergency response communications system, such as the system from FIG. 5, according to an exemplary embodiment. As illustrated, the first step in this nonlimiting example is to receive an emergency response request (block 1132). The emergency response request can take the form of someone dialing “911” or other means of receiving this information. Once this communication is received, a determination of the desired emergency response divisions can be made (block 1134). Then, a determination can be made of the desired emergency response teams (block 1136). Block 1134 and block 1136 differ in that block 1134 refers to determining whether a fire department, a hospital, a police station, etc. is desired to respond to this emergency. Once that determination is made, block 1136 determines which station or stations are desired. The determination of block 1136 can depend on location, station capabilities, whether the station is currently responding to another emergency, etc.

Next, a default route for the emergency response team (an unit) can be determined based on any of a plurality of information including but not limited to the emergency response team's location, the emergency's location, and information received from other units. As a nonlimiting example, a determination that a fire station is needed to respond to a fire. A determination can be made which fire station is most desirable to respond to this emergency. The determination can be made by estimated time of arrival, versus the estimated time of arrival of other stations. Additionally, if an emergency response unit is known to be currently located close to the emergency, a determination can be made that even though the fire station related to this unit is not the closest to the emergency, this unit can respond faster than any other unit due to its current location.

Next, a communication can be made to the emergency response unit(s) 100 that are desired to respond to the emergency (block 1138). Any of a plurality of information can also be communicated, such as the location of the emergency, a default route, the type of emergency, data related to other emergency response units, etc. After this information is communicated, a determination can be made as to whether any default route is blocked (block 1140). A default route may be blocked for any of a plurality of reasons including, but not limited to natural disasters, traffic, and accidents. If a communication is received indicating that a default route is blocked, a determination can be made whether a new route is desired (block 1142). As a nonlimiting example, if emergency response units A, B, C, and D are responding to an emergency (or emergencies) and emergency response unit A determines that a tree is blocking the road along its default route, emergency response unit A can determine whether moving the tree is an option, or whether a new route is desired (block 1144).

If it is determined that a new route is desired, the new route can be communicated to a unit (block 1146). Additionally, a determination can also be made as to whether other units currently in transit are routed to encounter the blocked path, and if so, a new route can also be provided to those units. One should note, that if unit A determines that a new route is desired, the visual detection system on that unit can communicate visual data related to blockage. This data can then be communicated to the other units for their determination of whether a new route is desired. Referring to a previous nonlimiting example, if a tree is blocking the path, unit A can request a new route. A determination can be made that unit B will also encounter this blockage, and visual data related to the blockage can be communicated to unit B, along with a prompt for a new route. By analyzing the visual data, the emergency response team associated with unit B can determine whether they desire to remove the tree, drive over the tree, or find another route. Once the general location has been identified and a default route has been established, an icon is projected into the windshield for the driver to see.

One should also note that while the above disclosure discusses a system related emergency response units. As is evident to one of ordinary skill in the art, other configurations could also include pedestrian vehicles, public transportation, aircraft, or other forms of transportation.

It should be emphasized that many variations and modifications may be made to the above-described embodiments. All such modifications and variations are intended to be included herein within the scope of this disclosure and protected by the following claims.

1. A system for providing data to a user, comprising:
detection logic configured to receive data related to an environment;
location logic configured to receive data related to the user's location;
execution logic configured to correlate at least a portion of the data received from the detection logic and at least a portion of the data related to the user's location; and
display logic configured to provide at least one cue related to the environment.

2. The system of claim 1, further comprising a windshield display generator configured to display the at least one visual cue to the user.

3. The system of claim 1, further comprising communications logic configured to communicate at least a portion of the data received by the detection logic to a communications network.

4. The system of claim 1, further comprising communications logic configured to communicate at least a portion of the data received by the location logic to a communications network.

5. The system of claim 1, further comprising storage logic configured to store at least a portion of the data received from at least one of the following: the location logic and the detection logic.

6. The system of claim 5, further comprising compare logic configured to compare at least a portion of the data stored by the storage logic with at least a portion of the data received from at least one of the following: the location logic and the detection logic.

7. The system of claim 1, further comprising at least one detection device configured to receive data related to the environment, wherein the at least one detection device is configured to recognize at least one of the following: a street name, a house number, a pedestrian, a road obstacle, a fire hydrant, a driveway, and a side street.

8. A method for providing data to a user, comprising:
receiving data related to an environment;
receiving data related to the user's location;
correlating at least a portion of the data received from the detection logic and at least a portion of the data related to the user's location; and
providing at least one cue related to the environment.

9. The method of claim 8, further comprising displaying the at least one visual cue to the user.

10. The method of claim 8, further comprising communicating at least a portion of the data received by the detection logic to a communications network.

11. The method of claim 8, further comprising communicating at least a portion of the data received by the location logic to a communications network.

12. The method of claim 8, further comprising storing at least a portion of the data received from at least one of the following: the location logic and the detection logic.

13. The method of claim 12, further comprising comparing at least a portion of the data stored by the storage logic with at least a portion of the data received from at least one of the following: the location logic and the detection logic.

14. The method of claim 8, wherein receiving data related to an environment comprises recognizing at least one of the following: a street name, a house number, a pedestrian, a road obstacle, a fire hydrant, a driveway, and a side street.

15. A computer readable medium for providing data to a user, comprising:
logic configured to receive data related to an environment;
logic configured to receive data related to the user's location;
logic configured to correlate at least a portion of the data received from the detection logic and at least a portion of the data related to the user's location; and
logic configured to provide at least one cue related to the environment.

16. The computer readable medium of claim 15, further comprising logic configured to display the at least one visual cue to the user.

17. The computer readable medium of claim 15, further comprising logic configured to communicate at least a portion of the data received by the detection logic to a communications network.

18. The computer readable medium of claim 15, further comprising logic configured to communicate at least a portion of the data received by the location logic to a communications network.

19. The computer readable medium of claim 15, further comprising logic configured to store at least a portion of the data received from at least one of the following: the location logic and the detection logic.

20. The computer readable medium of claim 19, further comprising logic configured to compare at least a portion of the data stored by the storage logic with at least a portion of the data received from at least one of the following: the location logic and the detection logic.
